(19) United States
(12) Patent Application Publication
(10) Pub. No.: US 2009/0071611 A1
(43) Pub. Date: Mar. 19, 2009

(54) Blinds

(76) Inventor: Steven Alexander Osmond, Bedfordshire (GB)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/793,723

(22) PCT Filed: Dec. 21, 2005
(86) PCT No.: PCT/GB05/05012

§ 371 Date: Apr. 7, 2008

(30) Foreign Application Priority Data
Dec. 22, 2004 (GB) 0428080.6

(51) Int. Cl. E06B 9/386; A47H 13/00

(52) U.S. Cl. 160/130; 160/368.1

(57) ABSTRACT

The invention relates to a blind of a set of parts for providing a window blind, comprising a plurality of blinds (1) each having a respective different indicia (2) and each having means (3) for supporting the blind at a surround (4) of a window (5). Suitably the support means (3) may be in the form of releasable engagement means such as hooks or hook-like elements at the head of the blind (1), for example held in a head tape. The hooks (3) are releasably engageable with hooks or hook-like elements (6) at a top rail (7) of a surround (4) of the window (5), which hooks 6 may be laterally slidably mounted in a guide for lateral sliding/folding of the blind. However, the blind may also be rollable on itself, or be of a Venetian blind-like construction, or comprised of vertical elements which are rotatable about their longitudinal axes to provide an open or closed blind.

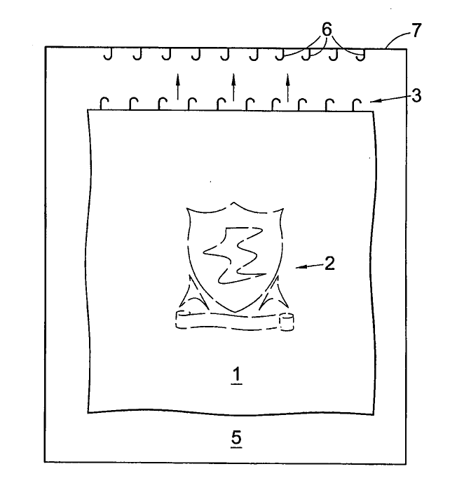

The invention relates to blinds, particularly to blinds (which term includes curtains, drapes and the like) which are mountable at a window to provide a desired aesthetic effect.

It is often the case that blinds as hereinbefore defined do not provide a desired aesthetic or emotional effect, particularly if allegiance to a particular sporting team or sport is desired by a user.

It is accordingly an object of the invention to seek to fulfill such a need.

According to a first aspect of the invention there is provided a set of parts for providing a window blind, comprising a plurality of blinds each having a respective different indicia and each having means for supporting the blind at a surround of a window.

Using the invention, one blind is readily replaceable by another as desired.

The indicia may be a discrete, separate, logo for each blind. This provides for changing of a blind to show say the insignia of different soccer clubs as desired.

The means may comprise a means which is releasably engageable with a support means at a window. This provides for ease of replacement, particularly when the means may comprise a hook-like means adapted for releasable engagement with the support means, which may itself comprise a hook means or an eye means, or a plurality of eye means.

The blind means may comprise a material which is rollable or drawable.

According to a second aspect, the invention provides a window blind, adapted to be replaceably supported at a window, and including a desired indicia on a major surface.

A blind of a set of parts is hereinafter described, by way of example, with reference to the accompanying drawing.

Referring to the drawing there is shown a blind (as hereinbefore defined), of a set of parts for providing a window blind, comprising a plurality of blinds 1 each having a respective different indicia 2 and each having means 3 for supporting the blind at a surround 4 of a window 5.

Suitably the support means 3 may be in the form of releasable engagement means such as hooks or hook-like elements at the head of the blind 1, for example held in a head tape. The hooks 3 are releasably engageable with hooks or hook-like elements 6 at a top rail 7 of a surround 4 of the window 5, which hooks 6 may be laterally slidably mounted in a guide for lateral sliding/folding of the blind.

Alternatively, the blind 1 may be rollable and unrollable vertically on itself, or of a Venetian blind construction, or may comprise a series of discrete vertical elongate elements which can be rotated simultaneously about their respective longitudinal axes to provide an open structure or closed blind.

The means 3, 6 will in the embodiments be separate from a mechanism for rolling the blind, or for operation when a Venetian blind construction or for operation of vertically extending blind members.

Moreover, when the blind is a Venetian blind or comprised of discrete vertical elements, each blind slat, part or element can carry part of the complete indicia, so that when the blind is operated by the mechanism to form a complete blind, i.e. to close a window off to viewing therethrough, the different parts combine visually to provide the complete indicia.

All the blinds 1 of a set have a discrete individual indicia such as the logo 2 for example that of a Premiership soccer team.

However, a particular blind 1 is demountable and replaced by another blind bearing its own discrete indicia, or logo, such as that of a county cricket team, so one blind can be replaced by another as desired.

Thus a set of parts can have any number of blinds, which can be put up for sale in a pack for easy selection of a blind bearing indicia in the form of a particular logo. The logo 2 may be a corporate logo or emblem, a sporting club or team emblem e.g. a national hockey league team, an NFL team, or the like, iconography e.g. “Elvis” or a sports person, pop or rock performers, groups or bands, or educational such as maps.

1. A set of parts for providing a window blind, comprising a plurality of blinds each having a respective different indicia and each having means for supporting the blind at a surround of a window.

2. A set according to claim 1, the indicia being a discrete, separate, logo for each one.

3. A set according to claim 1, the means comprising a means which is releasably engageable with a support means at a window.

4. A set according to claim 3, the means comprising a hook-like means adapted for releasable engagement with the support means.

5. A set according to claim 4, the support means comprising a hook means or an eye means, or a plurality of eye means.

6. A set according to claim 5, the blind comprising a material which is a selected one of rollable or drawable.

7. A set according to claim 1, the blinds each comprising a one-piece material blind.

8. A set according to claim 1, the blinds each comprising a plurality of discrete parts or elements which are turnable between a closed and an open position.

9. A set according to claim 8, the blinds each comprising a Venetian blind.

10. A window blind, adapted to be replaceably supported at a window, and including a desired indicia on a major surface.
